(19) United States
(12) Patent Application Publication
(10) Pub. No.: US 2019/0065987 A1
(43) Pub. Date: Feb. 28, 2019

(54) CAPTURING KNOWLEDGE COVERAGE OF MACHINE LEARNING MODELS

(71) Applicant: Accenture Global Solutions Limited, Dublin (IE)

(72) Inventors: Freddy Lecue, Dublin (IE); Jiewen Wu, Dublin (IE); Sara van de Moosdijk, `s-Hertogenbosch (NL)

(21) Appl. No.: 15/689,988

(22) Filed: Aug. 29, 2017

(51) Int. Cl. G06N 99/00; G06N 5/04

(52) U.S. Cl. CPC G06N 99/005; G06N 5/04

(57) ABSTRACT

Implementations are directed to receiving a first plurality of data sets associated with one or more of a process and a device, data values in the plurality of data sets being recorded by sensors in a set of sensors, receiving a first predictive model for the first plurality of data sets, for each data value in the first plurality of data sets, determining a knowledge score for the predictive model based on weights assigned to a plurality of concepts associated with a domain ontology for a domain of the one or more of the process and the device, comparing the knowledge score for each data value in the first plurality of data sets to a threshold knowledge score to provide a comparison, and in response to the comparison, selectively amending concepts in the first predictive model to provide a second predictive model.

### BACKGROUND

Predictive models are used in a variety of contexts to provide insight into processes. For example, predictive models are used to determine the probability of one or more outcomes of a process (e.g., predicting a class of input data). In some examples, a predictive model is developed using a machine learning process, and is trained based on training data (e.g., historical data). Predictive models tend to be a black-box to users. For example, data is input to a predictive model, and the predictive model provides output based on the data. The predictive model, however, does not provide indication as to what resulted in the output.

Robustness and accuracy of a predictive model are estimated using statistical techniques. In some examples, a predictive model is iteratively improved by identifying relevant data sets, and features in data sets, which optimize robustness and accuracy. However the discovery of relevant data sets and features remains a complex, and resource-inefficient task, because robustness and accuracy do not capture any explicit semantics of predictive models.

### SUMMARY

Implementations of the present disclosure are generally directed to capturing a metric, referred to herein as knowledge coverage, of machine learning models. More particularly, implementations of the present disclosure are directed to using knowledge coverage to drive selection of the machine learning model to provide an optimal knowledge coverage in a given domain ontology.

In some implementations, actions include receiving a first plurality of data sets associated with one or more of a process and a device, data values in the plurality of data sets being recorded by sensors in a set of sensors, receiving a first predictive model for the first plurality of data sets, for each data value in the first plurality of data sets, determining a knowledge score for the predictive model based on weights assigned to a plurality of concepts associated with a domain ontology for a domain of the one or more of the process and the device, comparing the knowledge score for each data value in the first plurality of data sets to a threshold knowledge score to provide a comparison, and in response to the comparison, selectively amending concepts in the first predictive model to provide a second predictive model. Other implementations of this aspect include corresponding systems, apparatus, and computer programs, configured to perform the actions of the methods, encoded on computer storage devices.

These and other implementations can each optionally include one or more of the following features: actions further include providing representative data based on the first plurality of data sets, and determining a semantic score for the representative data, the knowledge score being at least partially based on the semantic score; the semantic score is determined based on the weights, and the plurality of concepts are included in the representative data; the comparison provides that the knowledge score is below the threshold knowledge score, and, in response, the data in the first plurality of data sets is recomposed to provide the second plurality of data sets; actions further include recomposing data by determining, for each sensor in the set of sensors, a score based on respective sensor metadata, and selectively removing the data from the first plurality of data sets to provide the second plurality of data sets, in response to determining that a score of at least one sensor is below a threshold score; at least one sensor in the set of sensors includes an Internet-of-Things (IoT) device that monitors the process; the domain ontology is recorded in a computer-readable knowledge graph; concepts in the first predictive model are amended by removing one or more concepts based on the comparison; and concepts in the first predictive model are amended by adding one or more concepts based on the comparison.

Implementations of the present disclosure provide one or more of the following advantages. In some examples, a machine learning model is provided, which includes optimized knowledge coverage for a respective domain. Further, data sources for training data are optimized, which reduces noise in training data that is used to train the machine learning model. This also results in improved accuracy of the machine learning model. Further, the iterative process of the present disclosure enables users to adjust acceptance criteria to provide a machine learning model, and/or data sources that suit the user's particular needs.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts an example module architecture in accordance with implementations of the present disclosure.

FIG. 3 depicts an example portion of an example knowledge graph.

FIG. 4 depicts an example process that can be executed in implementations of the present disclosure.

### DETAILED DESCRIPTION

Implementations of the present disclosure are generally directed to capturing a metric, referred to herein as knowledge coverage, of machine learning models. More particularly, implementations of the present disclosure are directed to using knowledge coverage to drive selection of the machine learning model to provide an optimal knowledge coverage in a given domain ontology. In some examples, and as introduced above, a predictive model provides at least one result (e.g., a value), which can be described as a class of the input provided to the predictive model. Implementations of the present disclosure provide for iterative improvement of predictive models to provide a predictive model having an optimized knowledge coverage.

Implementations include actions of receiving a first plurality of data sets associated with one or more of a process and a device, data values in the plurality of data sets being recorded by sensors in a set of sensors, receiving a first predictive model for the first plurality of data sets, for each data value in the first plurality of data sets, determining a knowledge score for the predictive model based on weights assigned to a plurality of concepts associated with a domain ontology for a domain of the one or more of the process and the device, comparing the knowledge score for each data value in the first plurality of data sets to a threshold knowledge score to provide a comparison, and in response to the comparison, selectively amending concepts in the first predictive model to provide a second predictive model.

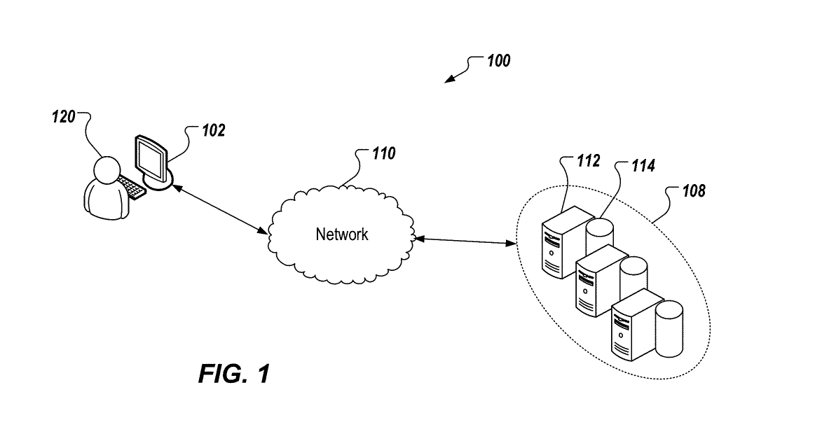

FIG. 1 depicts an example system 100 that can execute implementations of the present disclosure. The example system 100 includes a computing device 102, a back-end system 108, and a network 110. In some examples, the network 110 includes a local area network (LAN), wide area network (WAN), the Internet, or a combination thereof, and connects web sites, devices (e.g., the computing device 102), and back-end systems (e.g., the back-end system 108). In some examples, the network 110 can be accessed over a wired and/or a wireless communications link. For example, mobile computing devices, such as smartphones can utilize a cellular network to access the network 110.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host a computer-implemented service for executing predictive models, and interpreting results of predictive models in accordance with implementations of the present disclosure.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

As introduced above, implementations of the present disclosure are directed to using knowledge coverage to drive selection of the machine learning model to provide an optimal knowledge coverage in a given domain ontology. In accordance with implementations of the present disclosure, knowledge coverage is a metric (e.g., a score) that is representative of how well a predictive model covers a particular domain. In some implementations, and as described in further detail herein, a predictive model is selected based on a respective knowledge coverage. As described in further detail herein, implementations of the present disclosure include predictive model computation, representative data capture, semantic uplift, ranking and scoring, and data composition. In general, implementations of the present disclosure include iterative refinement of a predictive model until its knowledge coverage exceeds a threshold knowledge coverage for a respective domain.

Implementations of the present disclosure are described in further detail herein with reference to an example context. The example context includes food manufacturing, in which a predictive model is used to determine quality control (QC) levels based on data received from one or more devices that monitor food manufacturing processes (e.g., Internet-of-Things (IoT) devices). It is contemplated, however, that implementations of the present disclosure can be realized in any appropriate context. Other example contexts include maintenance of machines (e.g., robots), and retail. In the example context, food manufacturing is the domain, and an objective can include predicting the number of quality control checks to be performed. More specifically, an objective can include selecting a set of sensors for quality control checks, which reduce noise, and energy consumption. Example sensors can include IoT devices, which monitor a food manufacturing process, and provide data responsive to an environment, in which food is manufactured (e.g., temperature, humidity, pressure), and/or characteristics of the food being manufactured (e.g., temperature, sugar level).

In accordance with implementations of the present disclosure, a domain ontology is provided that is specific to the context. In the example context, the domain ontology includes information, such as key performance indicators (KPIs), for quality control in food manufacturing processes. In some implementations, the domain ontology is provided as a knowledge graph, or a portion of a knowledge graph. In some examples, a knowledge graph is a collection of data and related based on a schema representing entities and relationships between entities. The data can be logically described as a graph (even though also provided in table form), in which each distinct entity is represented by a respective node, and each relationship between a pair of entities is represented by an edge between the nodes. Each edge is associated with a relationship and the existence of the edge represents that the associated relationship exists between the nodes connected by the edge. For example, if a node A represents a person Alpha, a node B represents a person Beta, and an edge E is associated with the relationship “is the father of,” then having the edge E connect the nodes in the direction from node A to node B in the graph represents the fact that Alpha is the father of Beta. In some examples, the knowledge graph can be enlarged with schema-related knowledge (e.g., Alpha is a concept Person, Beta is a concept Person, and “is the father of” is a property or relationship between two entities/instances of concept Person). Adding schema-related information supports evaluation of reasoning results.

A knowledge graph can be represented by any of a variety of physical data structures. For example, a knowledge graph can be represented by triples that each represent two entities in order, and a relationship from the first to the second entity; for example, [alpha, beta, is the father of], or [alpha, is the father of, beta], are alternative ways of representing the same fact. Each entity and each relationship can be, and generally will be, included in multiple triples.

In some examples, each entity can be stored as a node once, as a record or an object, for example, and linked through a linked list data structure to all the relationships the entity has, and all the other entities to which the entity is related. More specifically, a knowledge graph can be stored as an adjacency list in which the adjacency information includes relationship information. In some examples, each distinct entity and each distinct relationship are represented with respective, unique identifiers.

The entities represented by a knowledge graph need not be tangible things or specific people. The entities can include particular people, places, things, artistic works, concepts, events, or other types of entities. Thus, a knowledge graph can include data defining relationships between people (e.g., co-stars in a movie); data defining relationships between people and things (e.g., a particular singer recorded a particular song); data defining relationships between places and things (e.g., a particular type of wine comes from a particular geographic location); data defining relationships between people and places (e.g., a particular person was born in a particular city); and other kinds of relationships between entities.

In some implementations, each node has a type based on the kind of entity the node represents; and the types can each have a schema specifying the kinds of data that can be maintained about entities represented by nodes of the type and how the data should be stored. For example, a node of a type for representing a person could have a schema defining fields for information such as birth date, birth place, and so on. Such information can be represented by fields in a type-specific data structure, or by triples that look like node-relationship-node triples (e.g., [person identifier, was born on, date]), or in any other convenient predefined way. In some examples, some or all of the information specified by a type schema can be represented by links to nodes in the knowledge graph, for example, [one person identifier, child of, another person identifier], where the other person identifier is a node in the graph.

In accordance with implementations of the present disclosure, the domain ontology can be weighted to indicate entities that may be more relevant for a given context. For example, and as described in further detail herein, a node within the domain ontology can include a respective weight, the higher the weight, the more relevant the entity represented by the node is to the subject being modeled.

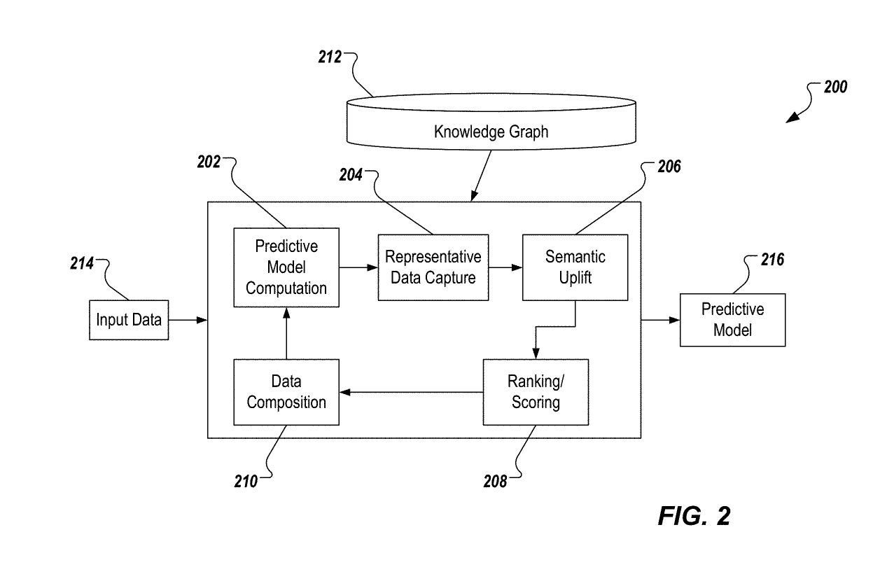

FIG. 2 depicts an example module architecture 200 in accordance with implementations of the present disclosure. The example module architecture 200 includes a predictive model computation module 202, a representative data capture module 204, a semantic uplift module 206, a ranking and scoring module 208, a data composition module 210, and a knowledge graph 212. As described in further detail herein, the example module architecture 200 processes input data 214 to provide a predictive module 216 that is optimized for knowledge coverage of a particular domain.

In accordance with implementations of the present disclosure, the input data 214 includes data sets (DSs) that can be used for training a predictive model (e.g., training data). In some examples, each data set corresponds to a particular parameter that is monitored by one or more IoT devices (e.g., temperature, humidity, sugar level). The following example tables depict example data sets based on the example context:

Data Set 1 (DS1): Thermometer Readings

| ID | Type | Temp (° C.) |
|---|---|---|
| 1 | Beer | 9 |
| 2 | Wine | 24 |
| 3 | Vodka | −4 |
| 4 | Whiskey | 8 |

Data Set 2 (DS2): Hygrometer Readings

| ID | Type | Humidity (%) |
|---|---|---|
| 1 | Beer | 10 |
| 2 | Wine | 23 |
| 3 | Vodka | 18 |
| 4 | Whiskey | 15 |

Data Set 3 (DS3): Sugar Level Sensor Readings

| ID | Type | Sugar Level (%) |
|---|---|---|
| 1 | Beer | 0.5 |
| 2 | Wine | 3.5 |
| 3 | Vodka | 0 |
| 4 | Whiskey | 5.5 |

In some examples, the data sets can be combined for types of entities (e.g., beverages in the example context), and can be associated with respective quality control grades to provide a set of transactions that can be used as training data. Using the example data sets above, the example transactions for beer and whiskey can be provided as:

Transaction Data: Beer and Whiskey

| Transaction ID | Food Type | Sensor Values | Data Set | QC Level |
|---|---|---|---|---|
| 1 | Beer | Thermometer = 9° | 1.1 | A− |
| | | Hygrometer = 10% | 2.1 | |
| | | Sugar Level = 0.5% | 3.1 | |
| 2 | Whiskey | Thermometer = 8° | 1.4 | C+ |
| | | Hygrometer = 15% | 2.4 | |
| | | Sugar Level = 5.5% | 3.4 | |

The example data sets and resulting transaction data are provided for illustration. It is contemplated that data sets and resulting transaction data can include hundreds, thousands, or millions of data values.

In accordance with implementations of the present disclosure, the data sets, and resulting transaction data are processed to train a predictive model. For example, the predictive model computation module 202 of FIG. 2 processes the data to provide a predictive model.

In some implementations, training of the predictive model can be performed using any appropriate training technique, and the predictive model can be provided in any appropriate form. Example training techniques and forms of predictive models include, without limitation, regression, support vector machine (SVM), random forest, and decision tree. In general, the predictive model captures one or more patterns in the training data. In the example context, the predictive model provides a quality control (QC) level for each food type.

In some implementations, the predictive model can be provided as a set of rules. For example, the predictive model can be provided as a decision tree that is representative of the set of rules. In the example context, example rules can include:

If TYPE=beer AND temperature≤10° AND humidity≤10% THEN QClevel=A−

If TYPE=whiskey AND humidity≤15% AND sugar level≤10% THEN QClevel=C+

In accordance with implementations of the present disclosure, representative data capture is performed to provide a data instance that represents test data. For example, the representative data capture is performed by the representative data capture module 204 of FIG. 2. It can be difficult to trace how a predictive model provides a predicted outcome for a test example (e.g., test data). This is compounded for relatively complex predictive models. In accordance with implementations of the present disclosure, representative data capture includes sampling certain types of data samples relative to a test example to provide a representative set of data points that can be used to understand patterns underlying the predicted value (e.g., output of the predictive model).

In accordance with implementations of the present disclosure, the representative data is provided from the training data used to train the predictive model. In some implementations, the representative data is provided as a set of training data that is sufficiently similar to selected test data. In the example context, example test data can be selected as:

| Transaction ID | Food Type | Sensor Value | Data Set | QC Level |
|---|---|---|---|---|
| 1 | Beer | Thermometer = 9° | 1.1 | A− |
| | | Hygrometer = 10% | 2.1 | |
| | | Sugar Level = 0.5% | 3.1 | |

### Example Test Data

In some examples, selection of data can be performed using random sampling, stratified sampling, or any appropriate sampling technique. More sophisticated sampling strategies can be used, such as perturbed sampling over a Gaussian distribution (or any other appropriate distribution).

In some examples, similarity between data is determined based on multi-dimensional similarity. For example, a distance can be determined between two data sets, the distance indicating a degree to which the two data sets are similar. In some examples, the shorter the distance, the more similar the data sets are. In some examples, a distance can include a cosine distance, which indicates a degree of similarity between two vectors, each vector representing a respective data set. For example, cosine similarity values can range between −1 and 1, where a cosine similarity value of 1 indicates similar (if not the same) test data, and a cosine similarity value of −1 indicates wholly dissimilar test data.

In some implementations, the distance between the selected test data and a data set of the training data is compared to a threshold distance to determine whether the data set is sufficiently similar to the test data to be provided as representative data. In the example case of cosine similarity, the cosine similarity value can be compared to the threshold cosine similarity value. If the cosine similarity value is greater than the threshold cosine similarity value, the data set is determined to be sufficiently similar to the test data. If the cosine similarity value is not greater than the threshold cosine similarity value, the data set is determined to not be sufficiently similar to the test data.

The following table depicts example representative data provided for the example context, and based on the example test data above:

| Explanations | | | | |
|---|---|---|---|---|
| ID | Food Type | Sensor Value | Data Set | QC Level |
| E₁ | Beer | Thermometer = 9° | 1.1 | A− |
| E₂ | Beer | Hygrometer = 10% | 2.1 | A− |
| E₃ | Whiskey | Sugar Level = 5.5% | 3.4 | C+ |

### Example Representative Data (Explanations (E))

In some examples, the representative data can each be referred to as explanations (E), as each provides insight as to why the predictive model was trained in the way it was trained.

In accordance with implementations of the present disclosure, semantic uplift is performed to provide a semantic score for each data set in the representative data, the semantic score indicating how well the respective data set represents the domain. For example, the semantic uplift is performed by the semantic uplift module 206 of FIG. 2. Semantic uplift can refer to lifting the underlying data to the semantic level using the domain ontology. More specifically, and as described in further detail herein, the semantic scores are determined based on the domain ontology provided in the weighted knowledge graph. Accordingly, a domain ontology is provided, which is relevant to the context of the predictive modeling. The representative data is mapped to concepts in the ontology, each of which has a weight assigned thereto. In some examples, the weight indicates a relative importance of the concept to the domain, as modeled by the ontology. In some implementations, the weights are used to determine the semantic score for each of the representative data sets.

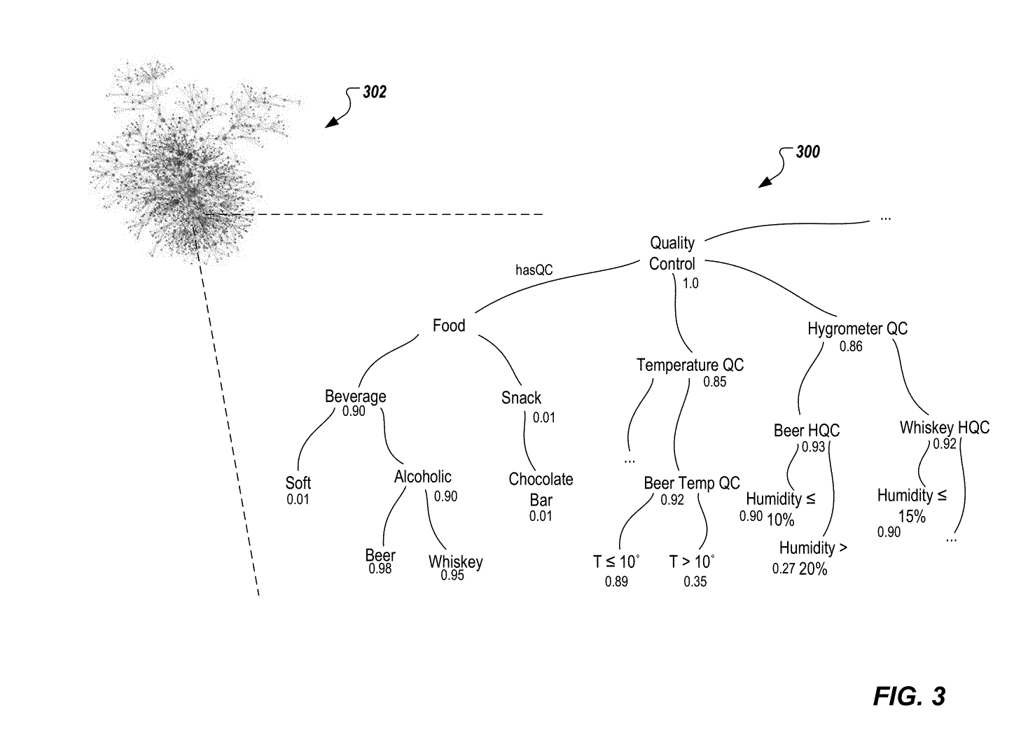

FIG. 3 depicts an example portion 300 of a knowledge graph 302, which represents at least a portion of the domain of the example context. In the example of FIG. 3, concepts corresponding to the example context are provided as nodes, and relationships between concepts are provided as edges. Each concept is associated with a weight that indicates a relative importance of the concept to the context. It is appreciated that the weights of FIG. 3 are example weights.

In some implementations, values of each data set are compared to the concepts, and, for each concept accounted for in the data set, the respective score is retrieved from the knowledge graph. For example, and with reference to the examples above (e.g., data sets E₁, E₂, E₃), Beer, Whiskey, Thermometer=9%, Hygrometer=10%, and Sugar Level=5.5% each correspond to concepts of the example knowledge graph 302 of FIG. 3, and respective weights are provided from the knowledge graph 302.

In some examples, the semantic score for a data set is determined based on the following example relationship:

$$\frac{{\sum }_{i = 1}^{n} {w}_{i}}{{\sum }_{j = 1}^{N} {w}_{j}}$$

where n is the concepts uplifted in the ontology, N is the total number of concepts in the ontology, and w is a concept weight.

In some implementations, a data score is provided, which indicates the amount of training data that is included in the representative data (e.g., the degree to which the representative data sets overlap the overall training data). In some examples, the data score as a fraction of data sets used. For example, and using the example described herein, if there are three data sets E₁, E₂, and E₃, then for each the data score is ⅓=0.33. In a subsequent iteration, described in further detail herein, data sets might be combined, resulting in a revised data score. For example, if E₁ and E₂ are combined, the data score would be ⅔=0.66.

Below are example data scores, and semantic scores for the example representative data provided above:

| | Data Score | Semantic Score |
|---|---|---|
| Transaction ID | (DS) | (SS) |
| E₁ | 0.33 | 0.54 |
| E₂ | 0.33 | 0.32 |
| E₃ | 0.33 | 0.09 |

### Example Scores for Representative Data

In accordance with implementations of the present disclosure, a knowledge coverage (also referred to as knowledge score, and/or knowledge coverage score) is determined for each data set in the representative data based on the semantic scores and the data scores. In some examples, each knowledge score (KS) can be determined based on the following example relationship:

KS=δ₁(DS)+δ₂(SS)

where δ₁ and δ₂ are respective weights (e.g., δ₁=0.5, δ₂=0.5). Using the examples from above, example knowledge scores are provided as:

| | Data Score | Semantic Score | Knowledge Score |
|---|---|---|---|
| Transaction ID | (DS) | (SS) | (KS) |
| E₁ | 0.33 | 0.54 | 0.435 |
| E₂ | 0.33 | 0.32 | 0.325 |
| E₃ | 0.33 | 0.09 | 0.210 |

### Example Knowledge Scores for Representative Data

In accordance with implementations of the present disclosure, the knowledge score for each data set can be compared to a threshold knowledge score. If a knowledge score exceeds the knowledge score threshold, the knowledge score, and the predictive model associated with the knowledge score are provided as output. That is, the predictive model corresponding to the data set having the sufficiently high knowledge score is determined to sufficiently capture the knowledge of the domain-specific ontology. Consequently, that predictive model is provided as output (e.g., to be used in production).

In accordance with implementations of the present disclosure, a predictive model can be provided for each data set. Consequently, a plurality of predictive models, and respective knowledge scores can be provided. In some examples, the knowledge scores of multiple predictive models can exceed the threshold knowledge score. In such instances, of the predictive models having knowledge scores exceeding the threshold knowledge score, the predictive model having the highest knowledge score is selected as the output. If none of the knowledge scores exceeds the knowledge score threshold, implementations of the present disclosure execute another iteration. More particularly, the training data that has been used in the previous iteration is recomposed to provide modified training data for training a subsequent predictive model. In some implementations, and as described in further detail herein, the data sets are recomposed based on additional metadata.

In some implementations, data composition (recomposition) is based on metadata of sensor (physical devices) used to record the training data (e.g., the data sets). In some examples, the metadata captures technical characteristics of the respective sensors. Example technical characteristics can include location, manufacturer, unique identifier, energy consumption, cost, defect rate, and the like. In some examples, the metadata can be provided as a table, each row representing a respective sensor, and each column representing characteristics. In some examples, the metadata of the table can be decomposed into multiple metadata vectors (MVs), each MV representing a particular sensor (e.g., thermometer, hygrometer). In some examples, an explanation vector (EV) can be provided, which includes a vector of the KSs of the respective explanations.

In some implementations, a plurality of scores can be determined based on the EV, and a respective MV. An example relationship can be provided as:

sᵢ=α∥EV∥+β∥MVᵢ∥

where α and β are respective weights, and i=1, . . . , m, m being the total number of sensors. Accordingly, a score s can be provided for each sensor. In some implementations, each score sᵢ is compared to a threshold score S_{THR}. In some examples, if a respective score exceeds the threshold score, data that was provided from the respective sensor remains in the training data. If a respective score does not exceeds the threshold score, data that was provided from the respective sensor is removed from the training data to provide the recomposed data. In accordance with implementations of the present disclosure, another iteration of training the predictive model is performed based on the recomposed training data, as described herein.

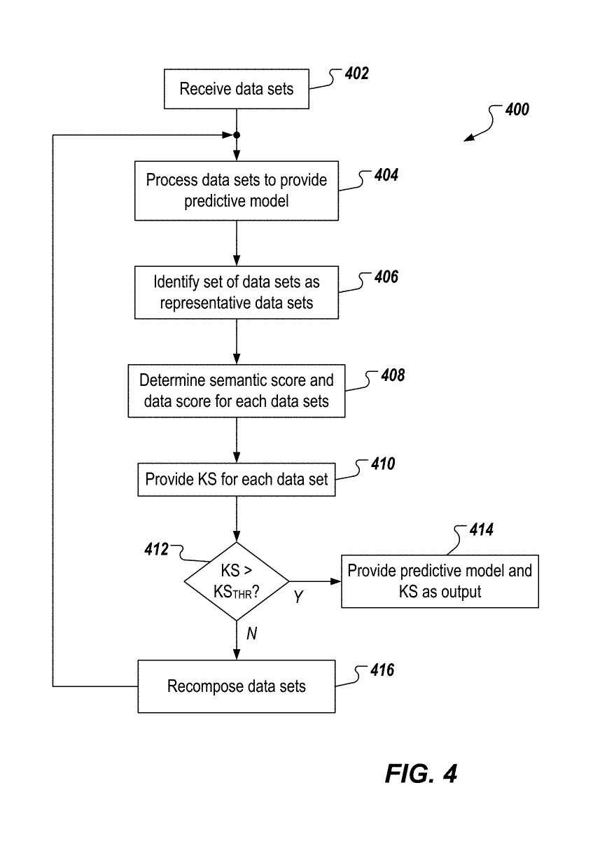

FIG. 4 depicts an example process 400 that can be executed in implementations of the present disclosure. In some examples, the example process 400 is provided using one or more computer-executable programs executed by one or more computing devices (e.g., the back-end system 108 of FIG. 1). The example process 400 can be executed to provide a predictive model that is based on a desired knowledge coverage for a given domain, as described herein.

Data sets are received (402). For example, data sets are received as training data, and include data values recorded by one or more devices (e.g., sensors monitoring a manufacturing process). The data sets are processed to provide a predictive model (404). For example, a predictive model is trained based on the training data. Representative data sets are identified (406). For example, and as described above, representative data sets are determined from the training data based on data set similarity. In some examples, each representative data set can be referred to as an explanations (E), as each provides insight as to why the predictive model was trained in the way it was trained.

A semantic score and a data score are determined for each data set (408). For example, and as described herein, the semantic score is determined based on concepts within each data set, and weights assigned to concepts within a domain ontology (e.g., recorded in a knowledge graph). A knowledge score is determined for each data set (410). For example, the knowledge score is determined based on the semantic score, and the data score for a respective data set (e.g., as a weighted sum). It is determined whether any of the knowledge scores exceed a knowledge score threshold (412). If a knowledge score exceeds the knowledge score threshold, the knowledge score, and the predictive model associated with the knowledge score are provided as output. If none of the knowledge scores exceeds the knowledge score threshold, the data sets are recomposed based on additional metadata (416), and the example process 400 loops back to provide a predictive model based on the recomposed data sets. In some examples, and as described above, the data sets are recomposed based on metadata of respective sensors used to record the data. For example, data provided from a sensor can be removed from the training data, if a respective score determined for the sensor is below a threshold score.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for providing a predictive model based on knowledge coverage, the method being executed by one or more processors and comprising:
receiving, by the one or more processors, a first plurality of data sets associated with one or more of a process and a device, data values in the plurality of data sets being recorded by sensors in a set of sensors;
receiving, by the one or more processors, a first predictive model for the first plurality of data sets;
for each data value in the first plurality of data sets, determining, by the one or more processors, a knowledge score for the predictive model based on weights assigned to a plurality of concepts associated with a domain ontology for a domain of the one or more of the process and the device;
comparing, by the one or more processors, the knowledge score for each data value in the first plurality of data sets to a threshold knowledge score to provide a comparison; and
in response to the comparison, selectively amending, by the one or more processors, concepts in the first predictive model to provide a second predictive model.

2. The method of claim 1, further comprising:
providing representative data based on the first plurality of data sets; and
determining a semantic score for the representative data, the knowledge score being at least partially based on the semantic score.

3. The method of claim 2, wherein the semantic score is determined based on the weights, and the plurality of concepts are included in the representative data.

4. The method of claim 1, wherein the comparison provides that the knowledge score is below the threshold knowledge score, and, in response, the data in the first plurality of data sets is recomposed to provide the second plurality of data sets.

5. The method of claim 1, further comprising recomposing data by:
determining, for each sensor in the set of sensors, a score based on respective sensor metadata; and
selectively removing the data from the first plurality of data sets to provide the second plurality of data sets, in response to determining that a score of at least one sensor is below a threshold score.

6. The method of claim 1, wherein at least one sensor in the set of sensors comprises an Internet-of-Things (IoT) device that monitors the process.

7. The method of claim 1, wherein the domain ontology is recorded in a computer-readable knowledge graph.

8. The method of claim 1, wherein concepts in the first predictive model are amended by removing one or more concepts based on the comparison.

9. The method of claim 1, wherein concepts in the first predictive model are amended by adding one or more concepts based on the comparison.

10. A non-transitory computer-readable storage medium coupled to one or more processors and having instructions stored thereon which, when executed by the one or more processors, cause the one or more processors to perform operations for providing a predictive model based on knowledge coverage, the operations comprising:
receiving a first plurality of data sets associated with one or more of a process and a device, data values in the plurality of data sets being recorded by sensors in a set of sensors;
receiving a first predictive model for the first plurality of data sets;
for each data value in the first plurality of data sets, determining a knowledge score for the predictive model based on weights assigned to a plurality of concepts associated with a domain ontology for a domain of the one or more of the process and the device;
comparing the knowledge score for each data value in the first plurality of data sets to a threshold knowledge score to provide a comparison; and
in response to the comparison, selectively amending concepts in the first predictive model to provide a second predictive model.

11. The computer-readable storage medium of claim 10, wherein operations further comprise:
providing representative data based on the first plurality of data sets; and
determining a semantic score for the representative data, the knowledge score being at least partially based on the semantic score.

12. The computer-readable storage medium of claim 11, wherein the semantic score is determined based on the weights, and the plurality of concepts are included in the representative data.

13. The computer-readable storage medium of claim 10, wherein the comparison provides that the knowledge score is below the threshold knowledge score, and, in response, the data in the first plurality of data sets is recomposed to provide the second plurality of data sets.

14. The computer-readable storage medium of claim 10, wherein operations further comprise recomposing data by:
determining, for each sensor in the set of sensors, a score based on respective sensor metadata; and
selectively removing the data from the first plurality of data sets to provide the second plurality of data sets, in response to determining that a score of at least one sensor is below a threshold score.

15. The computer-readable storage medium of claim 10, wherein at least one sensor in the set of sensors comprises an Internet-of-Things (IoT) device that monitors the process.

16. The computer-readable storage medium of claim 10, wherein the domain ontology is recorded in a computer-readable knowledge graph.

17. The computer-readable storage medium of claim 10, wherein concepts in the first predictive model are amended by removing one or more concepts based on the comparison.

18. The computer-readable storage medium of claim 10, wherein concepts in the first predictive model are amended by adding one or more concepts based on the comparison.

19. A system, comprising:
one or more processors; and
a computer-readable storage device coupled to the one or more processors and having instructions stored thereon which, when executed by the one or more processors, cause the one or more processors to perform operations for providing a predictive model based on knowledge coverage, the operations comprising:
receiving a first plurality of data sets associated with one or more of a process and a device, data values in the plurality of data sets being recorded by sensors in a set of sensors;
receiving a first predictive model for the first plurality of data sets;
for each data value in the first plurality of data sets, determining a knowledge score for the predictive model based on weights assigned to a plurality of concepts associated with a domain ontology for a domain of the one or more of the process and the device;
comparing the knowledge score for each data value in the first plurality of data sets to a threshold knowledge score to provide a comparison; and
in response to the comparison, selectively amending concepts in the first predictive model to provide a second predictive model.

20. The system of claim 10, wherein operations further comprise:
providing representative data based on the first plurality of data sets; and
determining a semantic score for the representative data, the knowledge score being at least partially based on the semantic score.

21. The system of claim 20, wherein the semantic score is determined based on the weights, and the plurality of concepts are included in the representative data.

22. The system of claim 19, wherein the comparison provides that the knowledge score is below the threshold knowledge score, and, in response, the data in the first plurality of data sets is recomposed to provide the second plurality of data sets.

23. The system of claim 19, wherein operations further comprise recomposing data by:
determining, for each sensor in the set of sensors, a score based on respective sensor metadata; and
selectively removing the data from the first plurality of data sets to provide the second plurality of data sets, in response to determining that a score of at least one sensor is below a threshold score.

24. The system of claim 19, wherein at least one sensor in the set of sensors comprises an Internet-of-Things (IoT) device that monitors the process.

25. The system of claim 19, wherein the domain ontology is recorded in a computer-readable knowledge graph.

26. The system of claim 19, wherein concepts in the first predictive model are amended by removing one or more concepts based on the comparison.

27. The system of claim 19, wherein concepts in the first predictive model are amended by adding one or more concepts based on the comparison.
